(19) United States
(12) Patent Application Publication
(10) Pub. No.: US 2018/0358708 A1
(43) Pub. Date: Dec. 13, 2018

(54) Amplitude Modulation of Electromagnetic Signals

(71) Applicant: ORYX VISION LTD., Petah Tikva (IL)

(72) Inventor: David BEN-BASSAT, Ganey Tikva (IL)

(21) Appl. No.: 16/060,523

(22) PCT Filed: Dec. 4, 2016
(86) PCT No.: PCT/IL2016/051295

§ 371 Date: Jun. 8, 2018

Related U.S. Application Data
(60) Provisional application No. 62/264,328, filed on Dec. 8, 2015.

(51) Int. Cl. H01Q 15/00; H01P 1/22; H04B 10/54

(52) U.S. Cl. CPC H01Q 15/002; H04B 10/541; H01P 1/222

(57) ABSTRACT

A system and a method are provided to amplitude modulate electromagnetic signals, wherein the system comprising at least one antenna coupled to a respective non-linear load configured to be provided with modulating signals, and wherein the electromagnetic signals are amplitude modulated in accordance with impedance matching between the at least one antenna and its respective load.

### TECHNICAL FIELD

Embodiments of the present disclosure generally relate to the field of processing electromagnetic signals. More particularly, embodiments of the present disclosure relate to the field of modulating electromagnetic signals.

### BACKGROUND

Typically, in optical communication networks, modulated light is transmitted through a fiber optic medium. The fiber is perceived as a waveguide, guiding the modulated light (represented as an electromagnetic wave) from one point to another.

In order to convey information from one end of the fiber optic to its other end, light is modulated and conveyed in its modulated form. The most basic modulation technique is an on-off keying (“OOK”) (also known as light/dark). When such a modulation is used, light is considered as a single bit of “1” whereas dark is considered as a single bit of “0”. OOK is the most common and basic modulation technique, and is widely used in optical communications. OOK is the simplest form of amplitude-shift keying modulation that represents digital data as the presence or absence of a carrier wave. In its simplest form, the presence of a carrier (i.e. presence of light) for a. specific duration represents a binary “1”, while its absence (i.e. darkness) for the same duration represents a binary “0”. Some more sophisticated modulation schemes vary these durations to convey additional information.

While OOK is a very simple and a straightforward type of modulation, yet, it is associated with some implementation challenges, especially when used in optical communications. These challenges are translated into limitations in bandwidth/information rate, power efficiency and overall attainable communication range.

Amplitude modulation of electromagnetic signals is commonly used nowadays and OOK is typically carried out in Radio Frequency (RF) systems using an AM transmitter as a source oscillator, followed by a variable gain amplifier. The oscillator output is fed as an input to the amplifier, while the modulating signal controls the amplifier gain. This way, the output signal is amplitude modulated. A schematic diagram exemplifying a typical RF AM modulator is demonstrated in FIG. 1, wherein the power Vₒᵤₜ of the signal leaving the variable gain amplifier is a product of Vᵢₙ of the signal generated by the RF source, and V_{c}.

When optical systems are concerned, the scheme is somewhat different. The source oscillator is typically a laser, emitting a very narrow band of coherent light. By applying an “on and off” DC biasing of the laser, its output is switched between light and dark—thereby achieving the required OOK modulation. A schematic diagram exemplifying a typical OOK transmitter is illustrated in FIG. 2.

Still, simple AM modulation schemes, and in particularly OOK type of modulation for optical signals, involves several drawbacks, among which:
Power efficiency: switching a laser on and off in order to obtain the desired effect, leads to charging and discharging the parasitic capacitance of that laser. Thus, every time a laser is switched on it requires charging its parasitic capacitor, whereas every time such a laser is switched off, it requires discharging its parasitic capacitor. This parasitic capacitance loading has two direct implications:
   Wasted power: charging and discharging the parasitic capacitor is practically power being wasted. Assuming that the laser capacitance is C [Farad], the switching rate is f [Hz] and the switching voltage is V [Volts], for such a case, the power being consumed just for the switching of the laser, would be CV²f [Watts].
   Requirement for using powerful high speed current drivers: in order to drive the laser capacitive loading, powerful high speed current drivers are required. This, in turn, translates to expensive driving technologies and devices.
Speed limitation: lasers are by definition resonating elements. As such, they have a fairly high Quality factor (Q-Factor). High Q factor means it takes time to wake them up, and it takes time to shut them off. Thus, there is a physical limitation to the maximum OOK switching speed of the laser that may be achieved.
Lasers and drivers are typically associated with different technologies. Thus, an interconnector would typically be required. Usually, lasers are interconnected to the drivers by wire bonds. This means that more parasitic elements (inductance and capacitance) are used, which is directly translated to a lower power efficiency.

Therefore, the present invention. seeks to provide a novel solution to amplitude modulation of electromagnetic signals, and in particularly to OOK modulation of light, a solution which overcomes many of the drawbacks associated with prior art OOK schemes.

### SUMMARY

The disclosure may be summarized by referring to the appended claims.

In view of the drawbacks of conventional methods, it is an object of the present invention to provide unique and innovative method and system for modulating electromagnetic signals.

It is another object of the present disclosure to provide a method and an apparatus for carrying out amplitude modulation by loading the propagating electromagnetic field, rather than turning on and off the signal generating source.

It is another object of the disclosure to provide a method and an apparatus which rely on using one or more antennas provided with a changeable non-linear load, thereby changing the impedance matching between the antenna and the medium in order to obtain the desired modulation.

Other objects of the present disclosure will become apparent from the following description.

According to one embodiment, there is provided a system configured to amplitude modulate electromagnetic signals, wherein the system comprising at least one antenna coupled to a respective electrical load configured to be provided with one or more modulating signals, and wherein the electromagnetic signals are amplitude modulated in accordance with impedance matching between the at least one antenna and its respective load.

In the following description reference is made at times to amplitude modulation of light. It should be understood however that the system and method described herein are applicable for the entire electromagnetic spectrum, and thus when reference is being made to light modulation, still it should be understood as encompassing an applicable range as the case may be of the full electromagnetic spectrum, and riot only to the part of the electromagnetic spectrum associated with visible light.

According to another embodiment, the load of the at least one antenna is a non-linear load, and is DC biased by at least one of the one or more modulating signals. A non-linear load as used herein through the specification and claims is used to denote a load where the current-voltage relationship (i.e. the I(V) function) cannot be described by a linear equation. Such a load, exhibits a differential load (dV/dI) that varies with the DC bias point of the load.

In accordance with another embodiment, the load of the at least one antenna is a metal-insulator-metal (MIM) load.

By yet another embodiment, the electromagnetic signals are optical signals.

According to another embodiment, the system further comprising a waveguide for conveying the electromagnetic signals (in their unmodulated and,/or modulated form) along a pre-defined path.

According to still another embodiment, the system further comprises a modulating signal source and at least one blocker (e.g. a. series of chokes) operative to block the electromagnetic signals received by the at least one antenna from reaching the modulating signal source.

By yet another embodiment, the system comprising a plurality of antennas each coupled to a respective MIM load, and wherein. the antennas are arranged serially along the waveguide, and wherein the same modulating signal is applied to each of the MIM loads, thereby enabling serial modulation of the electromagnetic signals as they propagate through the waveguide, by the plurality of antennas.

According to another aspect, there is provided a system configured to amplitude modulate electromagnetic signals, wherein the system comprising a plurality of antennas each coupled to a respective MIM load and configured to be provided with a respective modulating signal, and wherein each of the respective modulating signals is applied to each of the MIM loads, thereby obtaining amplitude modulation of the electromagnetic signals in accordance with impedance matching between each of the plurality of antennas and its respective load.

In accordance with another embodiment, the plurality of antennas is arranged along a waveguide and the system is configured to enable amplitude modulation of the electromagnetic signals by the plurality of antennas, as the electromagnetic signals propagate along the waveguide (e.g. serial modulation).

By yet another embodiment, at least two of the modulating signals provided to the plurality of antennas, are different from each other.

According to still another embodiment, the load coupled to each of the plurality of antennas is a non-linear load which is DC biased by a respective modulating signal provided to each of the plurality of antennas.

In accordance with another embodiment of this aspect of the invention, the electromagnetic signals are optical signals.

According to yet another aspect of the invention there is provided a method for amplitude modulating electromagnetic signals, wherein the method comprises the steps of:

providing at least one antenna coupled to a respective load;

providing modulating signals to the at least one respective load, for enabling amplitude modulation of the electromagnetic signals;

amplitude modulating the electromagnetic signals in accordance with impedance matching between the at least one antenna and its respective load.

According to another embodiment of this aspect, the step of amplitude modulating the electromagnetic signals comprises applying a non-linear load which is DC biased by the modulating signals to the respective load of the at least one antenna.

In accordance with another embodiment, the respective load of the at least one antenna is a metal-insulator-metal (MIM) load.

By yet another embodiment, the electromagnetic signals are optical signals.

In accordance with still another embodiment, a plurality of antennas are provided, each coupled to a respective MIM load, wherein the plurality of antennas are arranged in a serial configuration along a waveguide, and wherein the step of amplitude modulating the electromagnetic signals comprises applying the same modulating signal to each of the respective MIM loads, thereby enabling serially modulating the electromagnetic signals as they propagate through the waveguide, by the plurality of antennas.

### BRIEF DESCRIPTION OF THE DRAWINGS

The accompanying drawings, which are incorporated herein and constitute a part of this specification, illustrate several embodiments of the disclosure and, together with the description, serve to explain the principles of the embodiments disclosed herein.

FIG. 1 is a schematic representation of a prior art circuit exemplifying a typical RF AM modulator;

FIG. 2 is a schematic illustration exemplifying a typical prior art OOK transmitter;

FIG. 3 illustrates an antenna loaded with a perfect open or short load;

FIG. 4 illustrates an antenna loaded with a perfectly matched load;

FIG. 5 illustrates a typical differential resistance of a MIM structure, versus its DC bias voltage;

FIG. 6 illustrates a system construed in accordance with an embodiment of the invention, for carrying out an amplitude modulation by using a single antenna coupled to a MIM load; and

FIG. 7 demonstrates a system construed in accordance with another embodiment of the invention, for carrying out an amplitude modulation by using a plurality of antennas, each coupled to a MIM load.

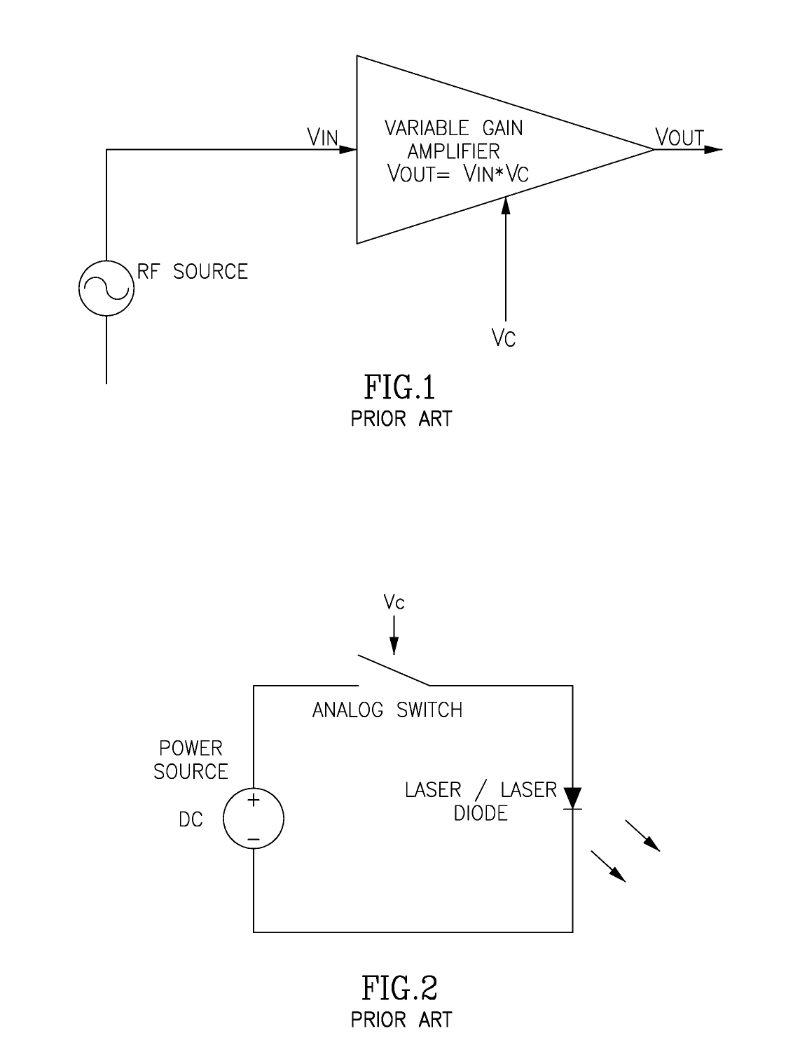

### DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention. The scope of the invention can be summarized by referring to the appended claims.

The following description relates to a method and an apparatus for implementing a unique and innovative approach of light modulation. The approach demonstrated in the following description is based on loading the propagating electromagnetic field, rather than on switching the light source on and off. The loading of the electromagnetic field is done by placing one or more antennas in the field, and actively changing its loading. Thus, actively changing the impedance matching between the antenna and the medium, and consequently changing the power being transferred between. the medium and the antenna(s).

Let us now consider a setup, where an antenna is placed in a medium where an electromagnetic wave is propagating.

Assuming that the antenna is properly designed, the electromagnetic wave will induce AC currents across the antenna, as propagates therethrough.

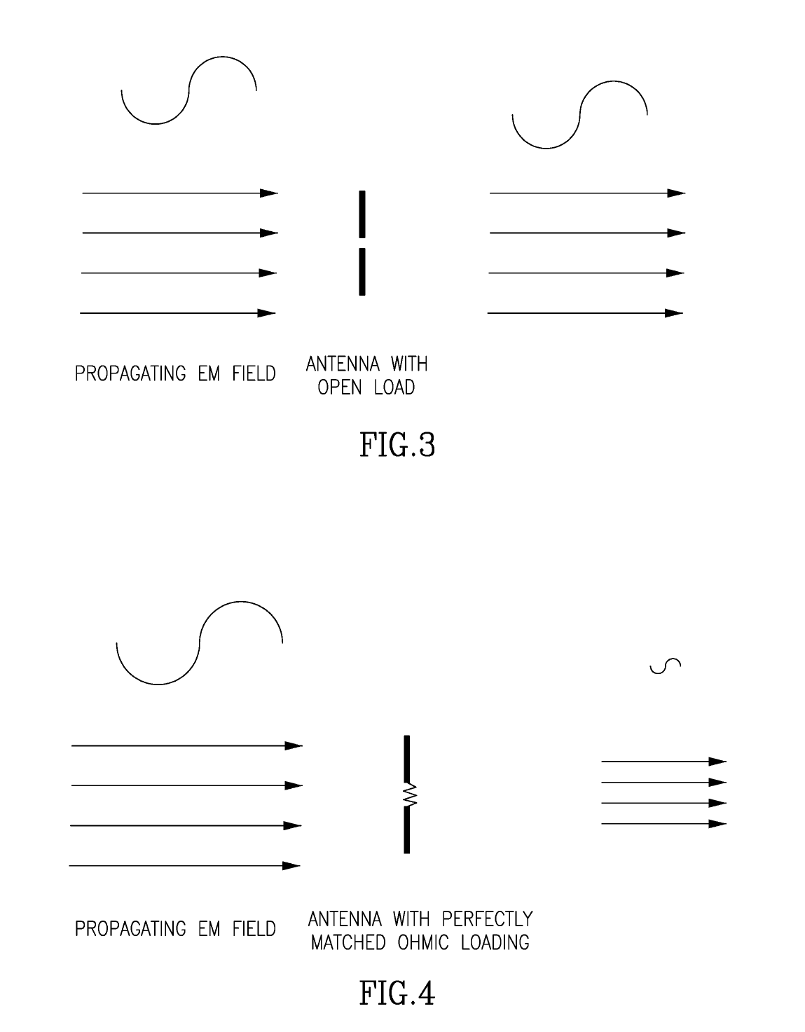

Next, the energy balance of this setup is analyzed. To do so, let us consider the following two extreme scenarios:
Scenario 1: the antenna is loaded using a perfect open. or short load. Open or short loads cannot consume any electrical energy, and accordingly, the currents being induced across the antenna arms will not impose any electrical energy on the load. In this case, the antenna may either reflect the energy back (i.e. a reflection mechanism) or would allow the electromagnetic energy to propagate through (i.e. a transmission mechanism). However, in both cases, all energy will remain within the electromagnetic field. This scenario is presented in FIG. 3, for a case where the antenna is open and transmits the energy therethrough.

Scenario 2: the antenna is loaded with a perfectly matched load. The term “a perfectly matched load” as used herein is used to denote a load that would cause absorption of all the electromagnetic energy picked by the antenna. In this case, the antenna absorbs the energy it has picked (i.e. absorption mechanism), and consequently the propagating electromagnetic field energy would be decreased by the very same amount of energy that was picked by the antenna. This scenario is presented in FIG. 4, for a case where the antenna is perfectly loaded and absorbs a significant portion of the energy through it.

A basic principle of the proposed solution relies on coupling one or more antennas to the electromagnetic field while allowing the electromagnetic waves to propagate along a waveguide. As the wave propagates, it is coupled to the antenna(s) along the waveguide. When coupled to the antenna(s), the electromagnetic wave may either go through or be reflected (it would go through for example, if the antenna(s) is/are not properly loaded, and would be reflected to the electromagnetic field either under open or short load conditions); or be absorbed by the antenna(s), if it/they is/are properly loaded.

Changing the electrical loading of the antenna(s), allows to amplitude modulate the electromagnetic field, as will be further explained.

An antenna coupled to a non-linear electrical load, may reflect different electro-magnetic loads by changing the DC bias of the non-linear load, for example, in case where an antenna coupled to a Metal-Insulator-Metal (MIM) structure, is used. MIM devices are well known in the art. They are two-port passive electrical devices, where two metals are separated from each other by a thin insulator. As voltage is applied across the metals, current appears to flow through the insulator utilizing the effect called ‘tunneling effect’. It can be shown that tunneling is a non-linear effect (as the current increases exponentially as a result of a linear increase in the voltage), and thus a MIM acts as a non-linear electrical load.

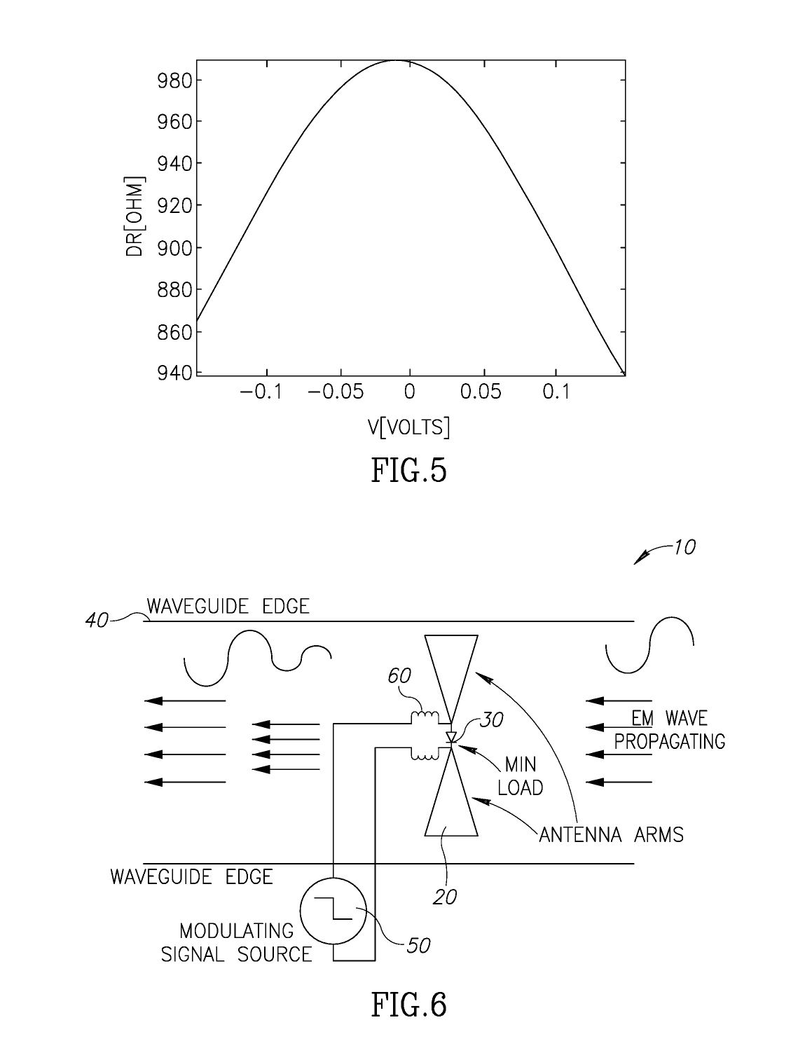

When coupling a MIM device (structure) to an antenna feed point, the loading perceived by the antenna is the differential load (dV/dI) as reflected by the MIM device. It can be shown that by DC biasing the MIM structure, different loads shall be reflected to the antenna—hence different impedance matching points are formed. FIG. 5 illustrates a typical differential resistance of a MIM structure, versus its DC bias voltage. As may be seen in FIG. 5, the impedance reflected by a MIM device may be changed by about 20% if one switches the DC bias point between 0 Volts and 100 mVolts.

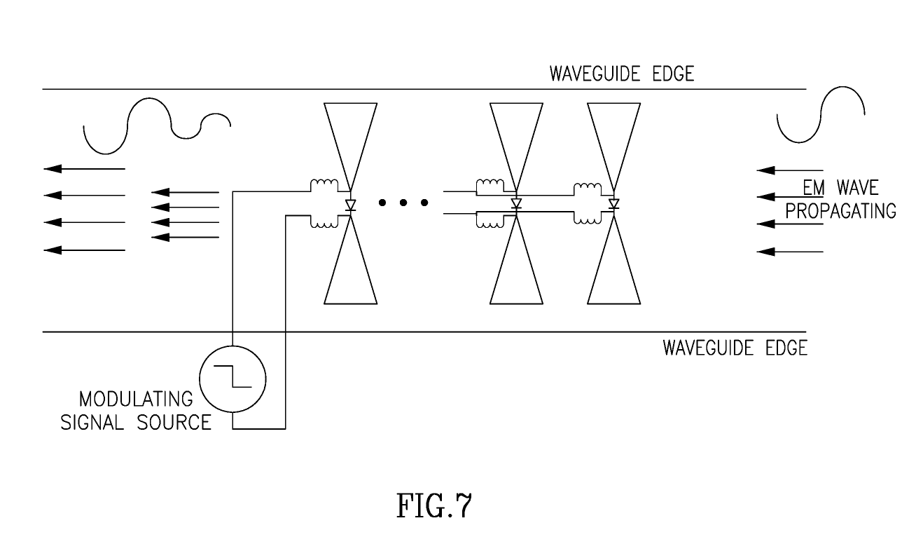

FIG. 6 illustrates an embodiment of the invention of a system (10) for carrying out an amplitude modulation by using a single antenna (20) coupled to a MIM load (30). As the electromagnetic wave propagates along the waveguide (40), it comes across the antenna. The antenna load is formed by the use of the MIM (represented as a diode in FIGS. 6 and 7). The MIM is DC biased by an electrical modulating signal, generated by a modulating signal generator (50), and presents two possible loads to the antenna—based on the DC voltage across it (as may be seen for example in FIG. 5). Accordingly, the electromagnetic field amplitude is modulated, based on the impedance matching between the antenna and the MIM load. The inductors in series (60) represents chokes, used to block the signal picked by the antenna from reaching the leads of the modulating signal source. Typically, these chokes are inherently built into the system, as part of the overall topology of the conductors.

FIG. 7 demonstrates another embodiment of the invention of a system for carrying out an amplitude modulation by using a plurality of antennas coupled to a MIM load, wherein the antennas are arranged serially along the waveguide. In this FIG., a series of antennas is illustrated, where each antenna is coupled to its own MIM load. All antenna loads are modulated in unison, with a single modulating signal. As the electromagnetic wave propagates through the waveguide, it is modulated by each of the antennas, in series. Such a topology yields a much better pronounced modulation depth, even if a single antenna does not reflect a perfect load to the signal. For example: if each antenna modulates only 2% of the signal (i.e. the best impedance match will only pick 2% of the signal), a sequence of 100 antennas will still yield a total modulation depth of 0.98′100=13.2%.

There are certain advantages that are associated with the solution described hereinabove, when compared with prior art OOK type of modulation schemes. Some of the main advantages are the following:
Energy consumption: the proposed scheme presents a major saving in power consumption when compared to existing OOK modulation schemes, as clearly demonstrated in the following Table 1:

TABLE 1

| | | Antenna coupled MIM | Laser switching |
|---|---|---|---|
| | | modulator | modulator |
| Rate | Hz | 1.00E+10 | 1.00E+10 |
| Capacitance | F | 1.00E−17 | 1.00E−12 |
| V+ | V | 0.1 | 2.5 |
| V− | V | 0 | 0.7 |
| ΔV | V | 0.1 | 1.8 |
| Resistance | Ω | 100 | 10 |
| Power Consumption | mW | 0.05 | 194.40 |

Production cost: Antenna coupled MIM structures are thin film products, which may be fabricated by using a standard semiconductors technology. Implementing an OOK modulator with the proposed technology is substantially cheaper than using modulators which are known in the art per se.
Integration: the proposed solution can be easily integrated with semiconductor and silicon photonics based products. Integrated solutions are cheaper, and present lower parasitic elements—thus even more efficient power consumption.

Other embodiments of the invention will be apparent to those skilled in the art from consideration of the specification and practice of the invention disclosed herein, for example cases where the optical signals are conveyed to the antenna via a waveguide/optical fiber in the addition or in the alternative of being conveyed in free space. It is intended that the specification and examples be considered as exemplary only, with a true scope and spirit of the invention being indicated by the following claims.

What is claimed is:

1. A system configured to amplitude modulate electromagnetic signals, wherein said system comprising at least one antenna coupled to a respective load configured to be provided with modulating signals, and wherein said electromagnetic signals are amplitude modulated in accordance with impedance matching between the at least one antenna and its respective load.

2. The system of claim 1, wherein the load of the at least one antenna is a non-linear load which is DC biased by the modulating signals.

3. The system of claim 1, wherein the load of the at least one antenna is a metal-insulator-metal (MIM) load.

4. The system of claim 1, wherein the electromagnetic signals are optical signals.

5. The system of claim 1, further comprising a waveguide for conveying the electromagnetic signals along a pre-defined path.

6. The system of claim 5, wherein said system comprising a plurality of antennas each coupled to a respective MIM load, and wherein said plurality of antennas are arranged serially along the waveguide, and wherein the same modulating signal is applied to each of said MIM loads, thereby enabling serially modulating the electromagnetic signals as they propagate through said waveguide, by the plurality of antennas.

7. A system configured to amplitude modulate electromagnetic signals, wherein said system comprising a plurality of antennas each coupled to a respective MIM load and configured to be provided with a respective modulating signal, and wherein each of the respective modulating signals is applied to each of the MIM loads, thereby obtaining amplitude modulation of the electromagnetic signals in accordance with impedance matching between each of the plurality of antennas and its respective load.

8. The system of claim 7, wherein the plurality of antennas are arranged along a waveguide and the system is configured to enable modulation of the electromagnetic signals by the plurality of antennas, as the electromagnetic signals propagate along said waveguide.

9. The system of claim 7, wherein at least two of the modulating signals provided to said plurality of antennas, are different from each other.

10. The system of claim 7, wherein the load coupled to each of said plurality of antennas is a non-linear load which is DC biased by the respective modulating signal provided to each of said plurality of antennas.

11. The system of claim 7, wherein the electromagnetic signals are optical signals.

12. A method for affecting amplitude modulation onto electromagnetic signals, wherein the method comprising the steps of:
providing at least one antenna coupled to a respective load;
providing modulating signals to the at least one respective load, for enabling amplitude modulation of the electromagnetic signals;
amplitude modulating the electromagnetic signals in accordance with impedance matching between the at least one antenna and its respective load.

13. The method of claim 12, wherein the step of modulating said electromagnetic signals comprises applying a non-linear load which is DC biased by the modulating signals to the respective load of the at least one antenna.

14. The method of claim 12, wherein said respective load of the at least one antenna is a metal-insulator-metal (MIM) load.

15. The method of claim 12, wherein the electromagnetic signals are optical signals.

16. The method of claim 12, wherein a plurality of antennas are provided, each coupled to a respective MIM load, wherein said plurality of antennas are arranged in a serial configuration along a waveguide, and wherein said step of amplitude modulating said electromagnetic signals comprises applying the same modulating signal to each of said respective MIM loads, thereby enabling serially modulating the electromagnetic signals as they propagate through said waveguide, by the plurality of antennas.
